(19) United States
(12) Patent Application Publication
(10) Pub. No.: US 2008/0003515 A1
(43) Pub. Date: Jan. 3, 2008

(54) Method of preparing toner and toner prepared using the method

(75) Inventors: Yo-da Shin, Incheon (KR); Kyung-yol Yon, Seongnam-si (KR); Chang-kook Hong, Suwon-si (KR); Min-young Cheong, Seoul (KR); Sang-soon Lim, Seocheon-gun (KR); Su-bum Park, Daegu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/636,478

(22) Filed: Dec. 11, 2006

(30) Foreign Application Priority Data
Jun. 30, 2006 (KR) 10-2006-0060682

(51) Int. Cl. G03G 9/093

(52) U.S. Cl. 430/110.2; 430/137.11; 430/123.5

(57) ABSTRACT

A method of preparing toner, is provided by preparing a stabilizer dispersion solution using distilled water and a dispersing agent; forming droplets by discharging the toner composition including at least one polymerizable monomer, a colorant, wax, and an initiator into the stabilizer dispersion solution through a syringe needle; forming core particles by warming the droplets dispersed in the stabilizer dispersion solution; and forming shells by adding a polymerizable monomer, a cross-linking agent, and an initiator to the core particles. The diameter of particles of the toner can be efficiently adjusted by changing the manufacturing process of the polymerization toner. The distribution of the toner particle diameter is improved and thus no additional sorting process is required. Also, the transferring performance of the toner can be improved, and various colors can be realized by a simple process.

### CROSS-REFERENCE TO RELATED PATENT APPLICATION

This application claims the benefit under 35 U.S.C. § 119(a) of Korean Patent Application No. 10-2006-0060682, filed on Jun. 30, 2006 in the Korean Intellectual Property Office, the disclosure of which is hereby incorporated by reference in its entirety.

### BACKGROUND OF THE INVENTION

1. Field of the Invention

The present invention relates to a method of preparing toner and to a toner prepared using the method. More particularly, the invention is directed to a method of preparing toner by suspension polymerization using a syringe needle, and a toner prepared using the method. The invention is also directed to a method of forming images using the toner, and an image forming apparatus employing the toner.

2. Description of the Related Art

In an electrophotographic process or an electrostatic recording process, a developer used to form an electrostatic image or an electrostatic latent image may be a two-component developer, formed of a toner and carrier particles, or a one-component developer, formed of a toner only. The one-component developer may be a magnetic one-component developer or a nonmagnetic one-component developer. Plasticizers such as colloidal silica are often added independently into the nonmagnetic one-component developer to increase the flowability of the toner. Generally, coloring particles obtained by dispersing a colorant, such as carbon black, or other additives in a binding resin are used in the toner.

Methods of preparing toners include pulverization and polymerization. In the pulverization method, the toner is obtained by melting and mixing synthetic resins with colorants and, if needed, other additives, pulverizing the mixture and sorting the particles until particles of a desired size are obtained. In the polymerization process, a polymerizable monomer composition is manufactured by uniformly dissolving or dispersing a polymerizable monomer, a colorant, a polymerization initiator and, if needed, various additives such as a cross-linking agent and an antistatic agent. Next, the polymerizable monomer composition is dispersed in an aqueous dispersive medium which includes a dispersion stabilizer using an agitator to form minute liquid droplet particles. Subsequently, the temperature is increased and suspension polymerization is performed to obtain a polymerized toner having colored polymer particles of a desired size.

In an image forming apparatus such as an electrophotographic apparatus or an electrostatic recording apparatus, an electrostatic latent image is formed through light-exposing the surface of a photoreceptor which is uniformly charged. A toner is attached to the electrostatic latent image, and a resulting toner image is transferred to a transfer medium such as a paper through several processes such as heating, pressing, solvent steaming, and the like. In most fixing processes, the transfer medium with the toner image passes through fixing rollers and pressing rollers, and by heating and pressing, the toner image is fused to the transfer medium.

Images formed by an image forming apparatus such as an electrophotocopier should satisfy requirements of high precision and accuracy. Conventionally, a toner used in an image forming apparatus is usually obtained using pulverization. In the pulverization method, color particles having a wide range of sizes are formed. Hence, to obtain satisfactory developer properties, there is a need to sort the coloring particles obtained through pulverization according to size to reduce the particle size distribution. However, it is difficult to precisely control the particle size distribution using a conventional mixing/pulverizing process in the manufacture of toner particles suitable for an electrophotographic process or electrostatic recording process. Also, when preparing a minute particle toner, the toner preparation yield is low due to a sorting process. In addition, there is a limit to a change/adjustment of a toner design for obtaining desirable charging and fixing properties. Accordingly, polymerized toners, of which the size of particles is easy to control and which do not need to undergo a complex manufacturing process such as sorting, have come into the spotlight recently.

When a toner is prepared using a polymerization method, a polymerized toner with a desired particle diameter and diameter distribution can be obtained without pulverizing or sorting.

U.S. Pat. No. 6,033,822 to Hasegawa et al. discloses a polymerized toner wherein the polymerized toner includes core particles and shells covering the core particles that is prepared by suspension polymerization. However, it is still difficult to control the shape of the toner and the size of the particles using this method, and moreover, results in a wide distribution of the diameter of the particles.

U.S. Pat. No. 6,258,911 to Georges et al. discloses “bifunctional macromolecules and toner compositions therefrom” having a narrow polydispersity. This patent also discloses a method of emulsification-aggregation polymerization to prepare a polymer having free radicals that are covalently-bonded at both ends of the polymer. However, when using such a method, a surfactant may induce inverse effects and it is difficult to control the size of the latex particles.

### SUMMARY OF THE INVENTION

The present invention provides a method of preparing toner using simplified manufacturing processes, wherein the toner particle diameter can be easily controlled.

The present invention also provides a toner with excellent durability and transferring ability.

The present invention also provides a method of forming images using a toner having excellent durability and transferring ability.

The present invention also provides an image forming apparatus which employs a toner with excellent durability and transferring ability and thus can realize high quality images.

According to an aspect of the present invention, a method of preparing toner comprises: preparing a stabilizer dispersion solution from distilled water and a dispersing agent; forming droplets by discharging a toner composition from a syringe needle into the stabilizer dispersion solution, where the toner composition comprises at least one polymerizable monomer, a colorant, wax, and an initiator; forming core particles by warming the droplets dispersed in the stabilizer dispersion solution to polymerize the toner composition; and adding a polymerizable monomer, a cross-linking agent, and an initiator to the core particles to form shells on the core particles.

According to another aspect of the present invention, a toner is provided comprising: core particles prepared by preparing a stabilizer dispersion solution in a reactor from distilled water and a dispersing agent, forming droplets by discharging a toner composition through a syringe needle into the stabilizer solution, the toner composition comprising at least one polymerizable monomer, a colorant, wax, and an initiator, and warming the droplets dispersed in the stabilizer dispersion solution in the reactor; and shells formed on the core particles by adding polymerizable monomer, cross-linking agent, and initiator to the core particles.

According to another aspect of the present invention, a method is provided for forming an image comprising: forming a toned image by attaching a toner to the surface of a photoreceptor on which an electrostatic latent image is formed; and transferring the toned image using a transferring member, wherein the toner is prepared using the above described method.

According to another aspect of the present invention, an image forming apparatus is provided comprising: an organic photoreceptor; a charging unit for charging a surface of the organic photoreceptor; a unit for forming an electrostatic latent image on the surface of the organic photoreceptor; a unit for receiving toner; a unit for forming a toned image by developing the electrostatic latent image on the surface of the organic photoreceptor by supplying the toner, and a transferring unit for transferring the toned image from the surface of the photoreceptor to a transferring member, wherein the toner is prepared using the above described method.

According to the present invention, the particle diameter of the toner can be controlled freely and the distribution of the toner particle diameter is improved to provide toner having good transferring ability.

These and other aspects of the invention will become apparent from the following detailed description of the invention which disclose various embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view for illustrating a process of manufacturing toner according to an embodiment of the present invention;

FIG. 2 is an enlarged view of a portion A illustrated in FIG. 1, according to an embodiment of the present invention;

FIG. 3 illustrates an image forming apparatus according to an embodiment of the present invention employing toner prepared according to an embodiment of the present invention;

FIG. 4 illustrates the particle size distribution of the toner particles of Example 1, according to an embodiment of the present invention;

FIG. 5 illustrates the particle size distribution of the toner particles of Example 2, according to an embodiment of the present invention;

FIG. 6A illustrates the particle size distribution of the toner particles of Comparative Example 1, and FIG. 6B illustrates the particle size distribution of the toner particles of Comparative Example 1 after a sorting process, according to embodiments of the present invention; and

FIG. 7A illustrates the particle size distribution of the toner particles of Comparative Example 2, and FIG. 7B illustrates the particle size distribution of the toner particles of Comparative Example 2 after a sorting process, according to embodiments of the present invention.

### DETAILED DESCRIPTION OF THE INVENTION

The present invention will now be described more fully with reference to the accompanying drawings, in which exemplary embodiments of the invention are shown.

The present invention provides a method of preparing toner. The method comprises: preparing a stabilizer dispersion solution in a reactor from distilled water and a dispersing agent; forming droplets by discharging a toner composition through a syringe needle into the stabilizer dispersion solution where the toner composition includes at least one polymerizable monomer, a colorant, wax, and an initiator; forming core particles by warming the droplets dispersed in the stabilizer dispersion solution inside the reactor; and adding the polymerizable monomer, the cross-linking agent, and the initiator to the core particles to form shells on the core particles and form the toner.

The present invention also provides a method of preparing polymerized toner by suspension polymerization, wherein the size of the particles of the toner can be controlled more simply and the particle size distribution of the toner is considerably narrow than a conventional toner prepared by suspension polymerization. According to an embodiment of the present invention, a toner with a core-shell structure can be prepared using the suspension polymerization process below.

First, a stabilizer dispersion solution is prepared using distilled water and a dispersing agent.

Examples of the dispersing agent include an organic polymer dispersing agent, cellulose water-soluble resin, and an inorganic dispersing agent. The organic polymer dispersing agent may be one selected from the group consisting of polyvinyl alcohol, polyacrylate salts, polyethylene glycol, polyvinyl pyrrolidone, polyacrylic amide, and triphosphoric acid salts. The cellulose water-soluble resin may be one selected from the group consisting of methylcellulose, hydroxylethylcellulose, and hydroxylpropyl methylcelluose. The inorganic dispersing agent may be magnesium carbonate or magnesium hydroxide.

The content of the dispersing agent may be about 0.1 to 10 parts by weight based on 100 parts by weight of the stabilizer dispersion solution. The stabilizer dispersion solution is prepared by adding the dispersing agent to a storage tank in which distilled water is input and raising the temperature to about 60 to 90° C.

Next, the toner composition containing at least one polymerizable monomer, colorant, wax, and initiator is discharged into the stabilizer dispersion solution through a syringe needle to form droplets.

The polymerizable monomer may be one selected from the group consisting of aromatic vinyl monomer, acrylate monomer, and methacrylate monomer. Examples of the polymerizable monomers include styrene, monochlorostyrene, methylstyrene, dimethylstyrene, acrylate, methacrylate, methyl acrylate, ethyl acrylate, propylacrylate, butyl acrylate, 2-ethylhexylacrylate, methyl methacrylate, ethyl methacrylate, propyl methacrylate, butyl methacrylate, and 2-ethylhexylmethacrylate, but are not limited thereto.

The content of the polymerizable monomer may be about 3 to 50 parts by weight based on 100 parts by weight of the total content of the toner composition. When the content of the polymerizable monomer is less than 3 parts by weight based on 100 parts by weight of the total content of the toner composition, the yield is decreased. When the content of the polymerizable monomer is greater than 50 parts by weight, the stability of the toner is decreased.

For black toner, carbon black or aniline black may be used as a colorant. A nonmagnetic toner according to an embodiment of the present invention is efficient for preparing color toner.

For color toner, carbon black is used as a black colorant, and at least one of yellow, magenta, and cyan colorants is used as colored colorants.

Condensed nitrogen compound, isoindolinone compound, anthraquinone compound, azo metal complex or aryl imide compound may be used as a yellow colorant. Specifically, C.I. pigment yellow 12, 13, 14, 17, 62, 74, 83, 93, 94, 95, 109, 110, 111, 128, 129, 147, 168, 180, and the like may be used.

Condensed nitrogen compound, anthraquinone, quinacridone compound, basic dye lake compound, naphthol compound, benzo imidazole compound, thioindigo compound, or perylene compound may be used as a magenta colorant. Specifically, C.I. pigment red 2, 3, 5, 6, 7, 23, 48:2, 48:3, 48:4, 57:1, 81:1, 122, 144, 146, 166, 169, 177, 184, 185, 202, 206, 220, 221, or 254 may be used.

Copper phthalocyanine compound and derivatives thereof, anthraquinone compound, or basic dye lake compound may be used as a cyan colorant. Specifically, C.I. pigment blue 1, 7, 15, 15:1, 15:2, 15:3, 15:4, 60, 62, or 66 may be used.

The colorant may be used alone or in combination of at least two, and is selected in consideration of color, chromacity, luminance, resistance to weather, dispersibility in toner, and the like.

The content of the colorant may be about 0.1 to about 20 parts by weight based on 100 parts by weight of the polymerizable monomer. The content of the colorant has to be sufficient for coloring the toner. When the content of the colorant is less than 0.1 parts by weight, the coloring effect is not sufficient. When the content of the colorant is greater than 20 parts by weight, the manufacturing costs for toner increase, and thus no sufficient triboelectric charge can be obtained.

A wax may be appropriately selected according to the purpose of the final toner. Examples of the wax that can be used include polyethylene wax, polypropylene wax, silicone wax, paraffin wax, ester wax, carnauba wax, and metallocene wax, and the like, but are not limited thereto. The preferable melting point of the wax is about 50 to about 150° C. The components of the wax are physically closely adhered to the toner particles, but are not covalently bonded with the toner particles. The final toner composition is fixed on a final image receptor at a low fixing temperature and shows excellent final image durability and resistance to abrasion.

The content of the wax may be about 0.1 to about 30 parts by weight based on 100 parts by weight of the polymerizable monomer. When the content of the wax is less than 0.1 parts by weight based on 100 parts by weight of the polymerizable monomer, the effect of the addition of the wax is small. When the content of the wax is greater than 30 parts by weight, the durability and charging properties of the toner are decreased.

The toner composition may create radicals due to the initiator and the radicals may react with the polymerizable monomer. Examples of the initiator include persulfate salts such as potassium persulfate, ammonium persulfate, etc.; azo compounds such as 4,4-azobis(4-cyano valeric acid), dimethyl-2,2′-azobis(2-methyl propionate), 2,2-azobis(2-amidinopropane) dihydrochloride, 2,2-azobis-2-methyl-N-1,1-bis(hydroxymethyl)-2-hydroxyethylpropioamide, 2,2′-azobis(2,4-dimethyl valeronitrile), 2,2′-azobis isobutyronitrile, 1,1′-azobis(1-cyclohexanecarbonitrile); peroxides such as methyl ethyl peroxide, di-t-butylperoxide, acetyl peroxide, dicumyl peroxide, lauroyl peroxide, benzoyl peroxide, t-butylperoxy-2-ethyl hexanoate, di-isopropyl peroxydicarbonate, di-t-butylperoxy isophthalate, and the like. Also, an oxidization-reduction initiator which is made by combining the initiator and a reduction agent may be used as the initiator. The content of the initiator may be about 0.01 to about 5 parts by weight based on 100 parts by weight of the polymerizable monomer.

Hereinafter, a suspension-polymerization process according to an embodiment of the present invention will be described with reference to the attached drawings.

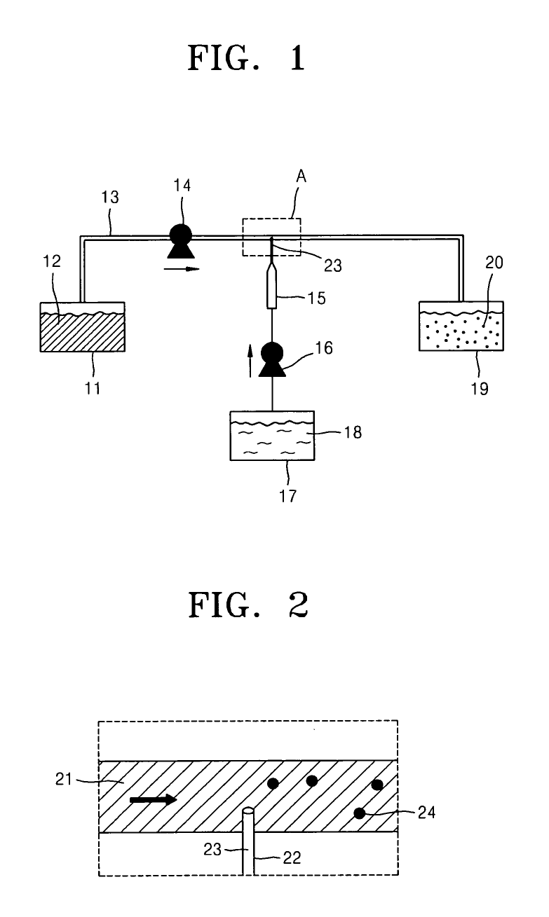

FIG. 1 is a schematic view for illustrating a process of manufacturing toner according to an embodiment of the present invention. FIG. 2 is an enlarged view of a portion A of FIG. 1, according to an embodiment of the present invention.

First, distilled water and a dispersing agent are injected to a first storage tank 11 and warmed to 70-80° C. to prepare a stabilizer dispersion solution 12. A pump 14 applies a predetermined pressure to the stabilizer dispersion solution 12 to move the stabilizer dispersion solution 12 through a pipe 13 toward a reactor 19.

A toner composition 18 containing at least one polymerizable monomer, a colorant, wax, and an initiator is injected to a second storage tank 17 which is pre-heated to 70 to 85° C., and continuously injected to a pre-heated syringe 15. A predetermined pressure is applied to the second storage tank 17 so that the toner composition 18 forms droplets 24 through a syringe needle 22. The diameter of a toner particle prepared in this manner can be adjusted to be from about 5 to about 100 μm according to the diameter of the syringe needle 22 and the viscosity control of a monomer compound. The average inner diameter of the syringe needle 22 may be about 0.005 to 0.1 μm, and toner particles can be efficiently adjusted by the diameter of the syringe needle 22. The monomer droplets 24 which are formed by passing the toner composition 18 through the syringe 15 and the inside 23 of the syringe needle are discharged from the syringe 15 and move to the reactor 19 while the droplets are maintained by the dispersion solution 21 which flows continuously through the pipe 13.

When the stabilizer dispersion solution 12 and a mixture 20 of the toner particles included in the stabilizer dispersion solution 12 all come into the reactor 19, core particles are formed in a cooling condenser and the reactor 19 under a nitrogen atmosphere at an agitation speed of 200 to 500 rpm, at a primary reaction temperature of 70-85° C. for 8 to 10 hours, and then at a secondary reaction temperature of 85 to 100° C. for 2 to 4 hours.

Shells can be formed by adding a polymerizable monomer, a cross-linking agent, and an initiator to the core particles. Here, the same polymerizable monomer and initiator used for forming core particles may be used. The cross-linking agent may be at least one selected from the group consisting of divinylbenzene, trimethylopropantriacrylate, pentaeritritholtriacrylate, and pentaeritritholtetracrylate.

A post-processing operation of separating and drying the toner particles with shells formed on the core particles may be included. The process of separating the toner particles with shells in the stabilizer dispersion solution 12 can be performed in various manners according to the kind of dispersing agent used. A predetermined basic solution or an acidic aqueous solution may be added, or alcohols such as ethanol, methanol, isopropyl alcohol, and the like may be used to remove the dispersing agent, or the toner particles with shells can be separated by repeating a washing process and a filtering process and then drying in a vacuum oven for 40 to 50 hours to obtain a final toner.

The toner composition according to the current embodiment of the present invention may further include at least one selected from a chain transfer agent, a release agent, and a charge control agent.

A chain transfer agent refers to a material that converts the type of a chain transfer material in a chain reaction. The polymerization of a monomer can be reduced and a new chain can be initiated by the chain transfer agent. The distribution of the molecular weight of polymer can be adjusted by the chain transfer agent.

Examples of the chain transfer agent include a sulfur containing compound such as dodecanthiol, thioglycolic acid, thioacetic acid, or mercaptoethanol; phosphorous acid compounds such as phosphoric acid and sodium phosphate; hypophosphorous acid compounds such as hypophosphorous acid and hypophosphorous natrium; and alcohols such as methyl alcohol, ethyl alcohol, isopropyl alcohol, and n-butyl alcohol, but are not limited thereto.

The release agent can be used to protect a photoreceptor and prevent deterioration of developing, thereby obtaining a high quality image. According to an embodiment of the present invention, the release agent may be a high purity solid fatty acid ester material. Examples of the release agent include low molecular weight polyolefins such as low molecular weight polyethylene, low molecular weight polypropylene, low molecular weight poly butylenes, and others; paraffin wax: multi-functional ester compound, and the like. The release agent used in the current embodiment of the present invention may be a multifunctional ester compound composed of alcohol having three functional groups or more and a carboxylic acid.

Examples of the alcohol having three functional groups or more include aliphatic alcohols such as glycerin, pentaerythritol, pentaglycerol, and the like; alicyclic alcohols such as chloroglycitol, xylitol, inositol, and the like; aromatic alcohols such as tris(hydroxymethyl)benzene, and the like; sugars such as d-erythrose, 1-arabinose, d-mannose, d-galactose, d-fructose, saccharose, maltose, lactose and the like.

Examples of the carboxylic acid, an example of the release agent, include aliphatic carboxylic acid such as acetic acid, butyric acid, caproic acid, enanthic acid, caprylic acid, pelargonic acid, capric acid, undecanoic acid, lauric acid, myristic acid, stearic acid, margaric acid, arachidic acid, cerotic acid, sorbic acid, linoleic acid, linolenic acid, behenic acid, tetrolic acid; aromatic carboxylic acid such as cyclohexanecarboxylic acid, hexahydroisophthalic acid, hexahydroterephthalic acid, 3,4,5,6-tetrahydrophthalic acid, and the like; aromatic carboxylic acid such as benzoic acid, cuminic acid, phthalic acid, isophthalic acid, terephthalic acid, trimellitic acid, hemimellitic acid, and the like.

The charge control agent may be selected from the group consisting of salicylic acid compound containing metal such as zinc or aluminum, boron complex of bis diphenyl glycolic acid, and silicate. For example, dialkyl salicylic acid zinc, boro bis(1,1-diphenyl-1-oxo-acetyl potassium salt), and the like can be used.

According to another embodiment of the present invention, a toner including core particles which are prepared by preparing a stabilizer dispersion solution in a reactor using distilled water and a dispersing agent, forming droplets by discharging a toner composition including at least one polymerizable monomer, a colorant, wax, and an initiator through a syringe needle into the stabilizer dispersion solution, and warming the droplets dispersed in the stabilizer dispersion solution in the reactor; and shells which are formed by adding a polymerizable monomer, a cross-linking agent, and an initiator to the core particles is provided.

The diameter of the toner particles is preferably about 5 to about 100 μm. The particle size of the resulting toner particles is determined by the inner diameter of the syringe needle. Generally, the particle size of the resulting toner is directly proportional to the inner diameter of the syringe needle and the droplets. Thus, in one embodiment, the inner diameter of the syringe needle forms droplets having a diameter of about 5 to about 100 μm to form toner particles having a diameter of about 5 to about 100 μm.

The polymerizable monomer may be at least one selected from a vinyl monomer, an acrylate monomer, and a methacrylate monomer. Specifically, the polymerizable monomer may be at least one selected from the group consisting of styrene, monochlorostyrene, methylstyrene, dimethylstyrene, acrylate, methacrylate, methyl acrylate, ethyl acrylate, propyl acrylate, butyl acrylate, acrylate 2-ethyl hexyl, methyl methacrylate, ethyl methacrylate, propyl methacrylate, butyl methacrylate, and methacrylate 2-ethyl hexyl, but is not limited thereto.

The toner according to the current embodiment of the present invention may further include an initiator, a chain transfer agent, a charge control agent, and a releasing agent, as previously described.

According to another embodiment of the present invention, a method is provided for forming an image including forming a visible image by attaching toner on the surface of a photoreceptor on which an electrostatic latent image is formed and transferring the visible image onto a transferring member, wherein the toner includes core particles which are prepared by preparing a stabilizer dispersion solution in a reactor using distilled water and a dispersing agent, forming droplets by discharging a toner composition including at least one polymerizable monomer, a colorant, wax, and an initiator through a syringe needle into the stabilizer dispersion solution, and warming the droplets dispersed in the stabilizer dispersion solution in the reactor; and shells which are formed by adding a polymerizable monomer, a cross-linking agent, and an initiator to the core particles is provided.

A representative electrophotographic image forming process includes charging, exposing to light, developing, transferring, fixing, cleaning, and erasing process, and a series of operations of forming images on a receiving medium.

In a conventional charging operation, negative or positive charges are applied to a photoreceptor by a corona or charge roller. In the light exposing operation, an optical system, conventionally a laser scanner or a diode arrangement, selectively discharges the charged surface of the photoreceptor in an imagewise manner corresponding to a desired image formed on a final image receptor to form a latent image. Electromagnetic radiation that can be referred to as “light” includes infrared radiation, visible light, and ultraviolet radiation.

In the developing operation, suitable polar toner particles generally contact the latent image of the photoreceptor, and conventionally, an electrically-biased developer having identical potential polarity to the toner polarity is used. The toner particles move to the photoreceptor and are selectively attached onto the latent image by electrostatic electricity, and form a toned image on the photoreceptor.

In the transferring operation, the toned image is transferred to final image receptor from the photoreceptor, and sometimes, an intermediate transferring element is used to transfer the toned image from the photoreceptor to the final image receptor.

In the fixing operation, the toned image of the final image receptor is heated and the toner particles thereof are softened or melted, thereby fixing the toned image on the final receptor. Another way of fixing is to fix toner on the final receptor under high pressure with or without heat being applied.

In the cleaning operation, remaining toner on the photoreceptor is removed.

Finally, in the erasing process, the charges on the photoreceptor are exposed to light of a predetermined wavelength band and are reduced to a substantially uniform, low value, and thus the residue of the original latent image is removed, and the photoreceptor is prepared for a next image forming cycle.

According to another embodiment of the present invention, there is provided an image forming apparatus comprising: an organic photoreceptor; a unit for charging a surface of the organic photoreceptor; a unit for forming an electrostatic latent image on the surface of the organic photoreceptor; a unit for receiving toner; a unit for forming a toner image by supplying toner to develop the electrostatic latent image of the organic photoreceptor; and a unit for transferring the toned image from the photoreceptor to a transferring medium. The toner is obtained by preparing a stabilizer dispersion solution using distilled water and a dispersing agent; forming droplets by discharging a toner composition comprising at least one polymerizable monomer, a colorant, wax, and an initiator into the stabilizer dispersion solution through a syringe needle; forming core particles by warming the droplets dispersed in the stabilizer dispersion solution; and forming shells on the core particles by adding a polymerizable monomer, a cross-linking agent, and an initiator to the core particles.

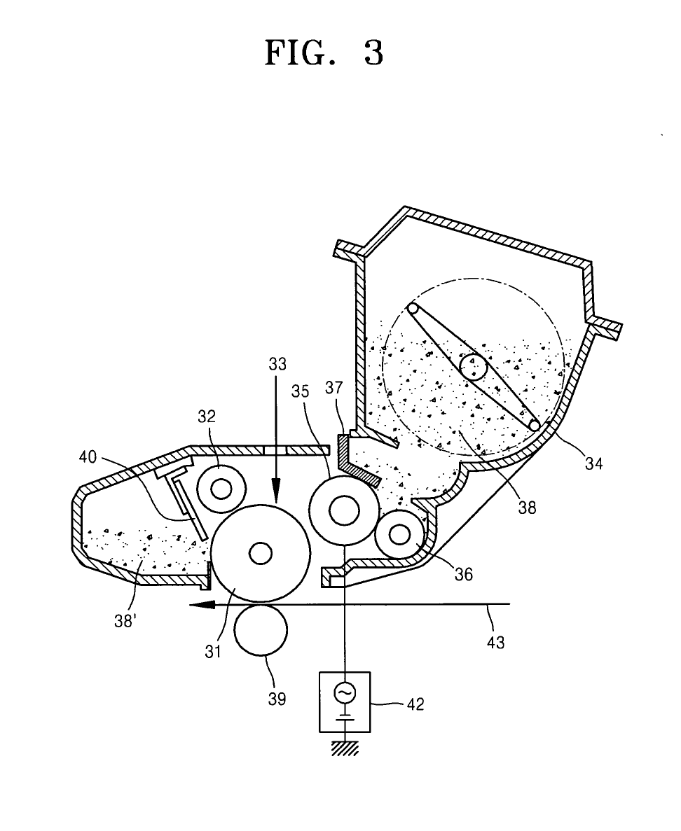

FIG. 3 illustrates a non-contact developing type image forming apparatus accommodating toner prepared according to the preparing method of the present invention, according to an embodiment of the present invention.

The nonmagnetic one-component developer transfers a developer 38 to a developing roller 35 using a supply roller 36 formed of an elastic member such as polyurethane foam, sponge, and the like. The developer 38 transferred to the developing roller 35 reaches a contact portion of a developer regulation blade 37 and the developing roller 35 by rotation of the developing roller 35. The developer regulation blade 37 is constituted of an elastic member formed of metal, rubber, or the like. When the developer 38 passes between the contact portion of the developer regulation blade 37 and the developing roller 35, the developer 38 is regulated to a predetermined thickness, and a thin layer of developer 38 is formed. The thin layer of developer 38 is transferred by the developing roller 35 to a developing region where the developer 38 is developed on an electrostatic latent image of a photoreceptor 31 which is a latent image carrier.

The developer roller 35 and the photoreceptor 31 face each other with a constant distance therebetween. The developing roller 35 rotates counter-clockwise and the photoreceptor 31 rotates clockwise. The developer 38 transferred to the developing region is developed as an electrostatic latent image of the photoreceptor 31 by the electricity generated by the potential difference of the voltage applied to the developing roller 35 and the potential of the latent image of the photoreceptor 31.

The developer 38 developed on the photoreceptor 31 is transferred to a sheet of paper 43, and as the paper 43 passes through the developer 38 developed on the photoreceptor 31 as corona discharge or as a roller by a transfer unit 39 to which a high voltage having inverse polarity with respect to the developer 38 is applied, thus forming an image.

The image transferred to the paper 43 passes through a high temperature and high pressure fixing unit (not shown) and the developer 38 is fused on the paper, thereby fixing the image. The remaining developer 38 that is not developed on the developing roller 35 is returned by a supplying roller 36 that contacts the developing roller 35. The above process is repeated.

The present invention will be described in more detail with reference to the examples below. However these examples are for illustrative purposes only and are not intended to limit the scope of the invention

### EXAMPLES

### Example 1

Preparation of Stabilizer Dispersion Solution

400 g of distilled water and 4 g of PVA (molecular weight of 170,000) as a dispersing agent were injected into a 500 ml storage tank, having a heat source and an agitator. The mixture was agitated while the temperature was raised to 70° C., to sufficiently dissolve the dispersing agent. The dispersing agent flows to the reactor continuously through a pipe while being maintained at a temperature of 70° C. during the manufacture of core particles.

Manufacture of Cores

A monomer composed of 148 g of styrene, 48 g of n-butyl acrylate and 14 g of acrylic acid, and a chain transfer agent composed of 0.02 g of n-dodesil mercaptan were introduced and then 10.5 g of carbon black was added and agitated using a bead mill at 6000 rpm for 5 minutes. Then, beads were removed to prepare 105 g of a monomer and pigment mixture. The temperature of the mixture was raised in a water bath at 70° C. and then 5 g of paraffin wax was added and agitated for 30 minutes for sufficient melting. 2 g of azobisisobutyronitryl was added as an initiator to the final monomer mixture, and agitated for 3 minutes to maintain the temperature at 70° C. or greater. The monomer mixture was put into a storage tank in which an agitator was installed and agitated and discharged by a syringe pump (microfeeder, KDS Model 100) through a syringe needle (diameter 0.01 μm) into the stabilizer dispersion solution which was continuously flowing to form monomer droplets. The toner composition in the stabilizer dispersion solution were maintained as droplets. The continuous formation of droplets continued until the monomer mixture was exhausted and the formed monomer droplets and the stabilizer dispersion solution were moved to the reactor. Inside the reactor, the reaction results moved from a water based storage tank and a monomer storage tank were collected. Inside a cooling condenser and the reactor under the nitrogen atmosphere, agitation speed was 400 rpm, the temperature was raised by stages, and the reaction temperature was maintained at 80° C. for 10 hours, and cores were prepared at a temperature of 90° C. for 3 hours.

20 g of styrene and 0.2 g of trimethylpropantriacrylate, constituting a monomer, were added to the prepared cores, and 0.2 g of azobisisobutylonitryl was added as an initiator and melted to form shells using a dropping funnel. The dispersing agent was removed from the final toner by sufficiently repeating a washing process and a filtering process with a mixture solution of water and ethanol, and was vacuum-dried to prepare toner.

The average diameter of particles of the prepared toner was 10.0 μm, and the particle size distribution was very narrow.

### Example 2

A toner was prepared in the same manner as in Example 1, except that the temperature of the monomer storage tank was raised to 75° C., and a syringe needle having a diameter of 0.005 μm was used. The average diameter of the prepared toner particles was 5.8 μm, and the particle size distribution was very narrow.

### Example 3

A toner was prepared in the same manner as in Example 1, except that a syringe needle having a diameter of 0.1 μm was used. The average diameter of the prepared toner particles was 100 μm, and the particle size distribution was very narrow.

### Example 4

A toner was prepared in the same manner as in Example 1 except that PB 15:3 was used instead of carbon black as a colorant. The average diameter of the prepared toner particles was 10.1 μm, and the particle size distribution was very narrow.

### Example 5

A toner was prepared in the same manner as in Example 1 except that PY 180 was used instead of carbon black as a colorant. The average diameter of the prepared toner particles was 10.3 μm, and the particle size distribution was very narrow.

### Example 6

A toner was prepared in the same manner as in Example 1 except that PR 122 was used instead of carbon black as a colorant. The average diameter of the prepared toner particles was 10.2 μm, and the particle size distribution was very narrow.

### Comparative Example 1

A toner was prepared in the same manner as in Example 1 except that a homogenizer was used at 8000 rpm for 20 minutes to form droplets instead of a syringe needle. The average diameter of the prepared toner particles was 9.89 μm, and the particle size distribution was very narrow.

### Comparative Example 2

A toner was prepared in the same manner as in Example 1 except that a homogenizer was used at 12000 rpm for 30 minutes to form droplets instead of a syringe needle. The average diameter of the prepared toner particles was 4.982 μm, and the particle size distribution was very wide.

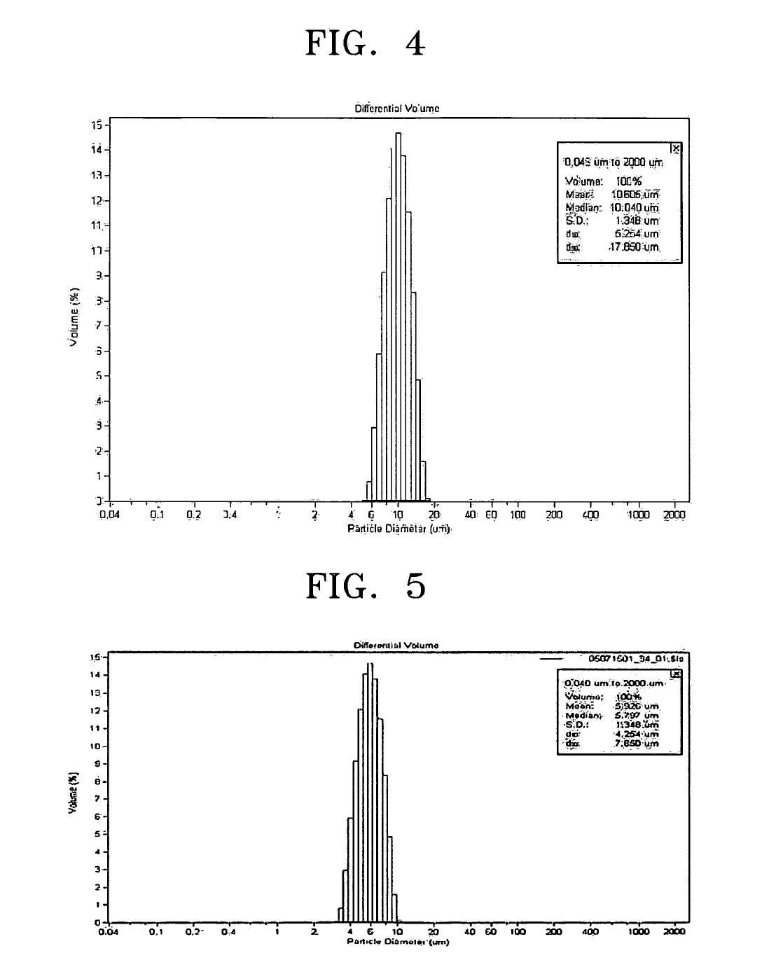

FIG. 4 illustrates the particle size distribution of the toner particles of Example 1. Referring to FIG. 4, the particle size distribution of the toner particles of Example 1 was very narrow and no additional sorting process is required, and thus the process is simplified.

FIG. 5 illustrates the particle size distribution of the toner particles of Example 2. Referring to FIG. 5, the particle size distribution of the toner particles of Example 2 was very narrow, and no additional sorting process was required, thereby simplifying the process.

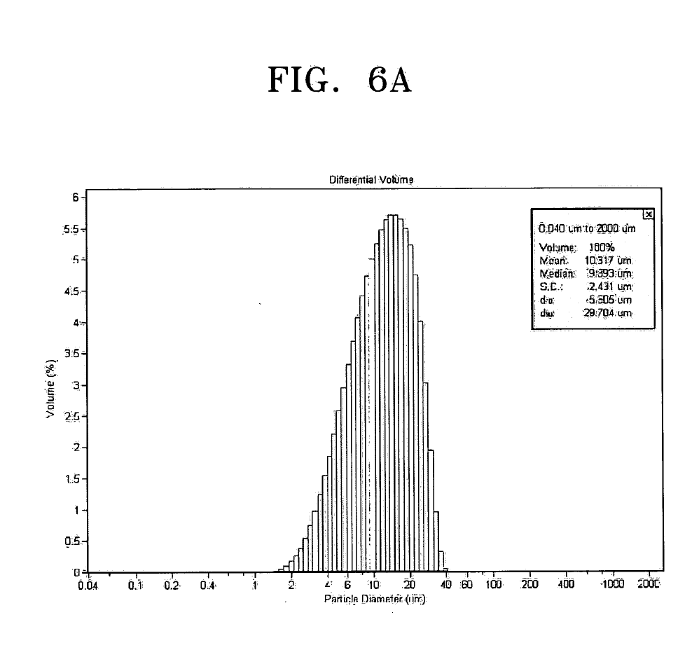

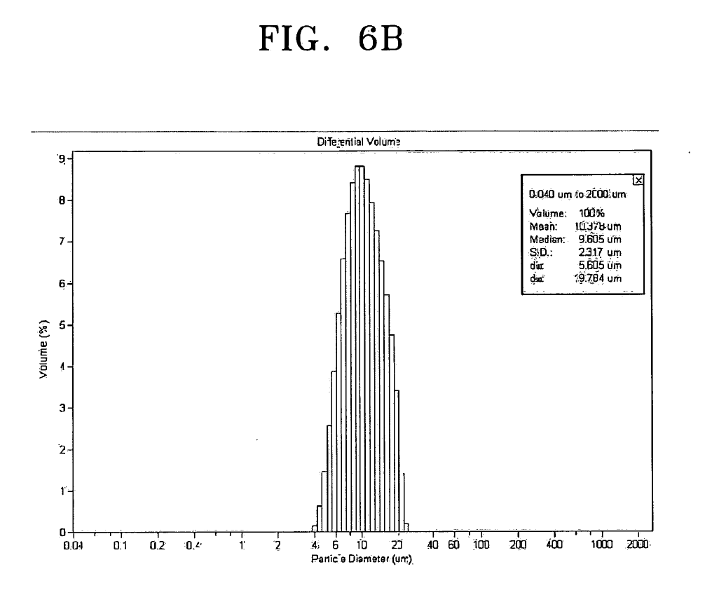

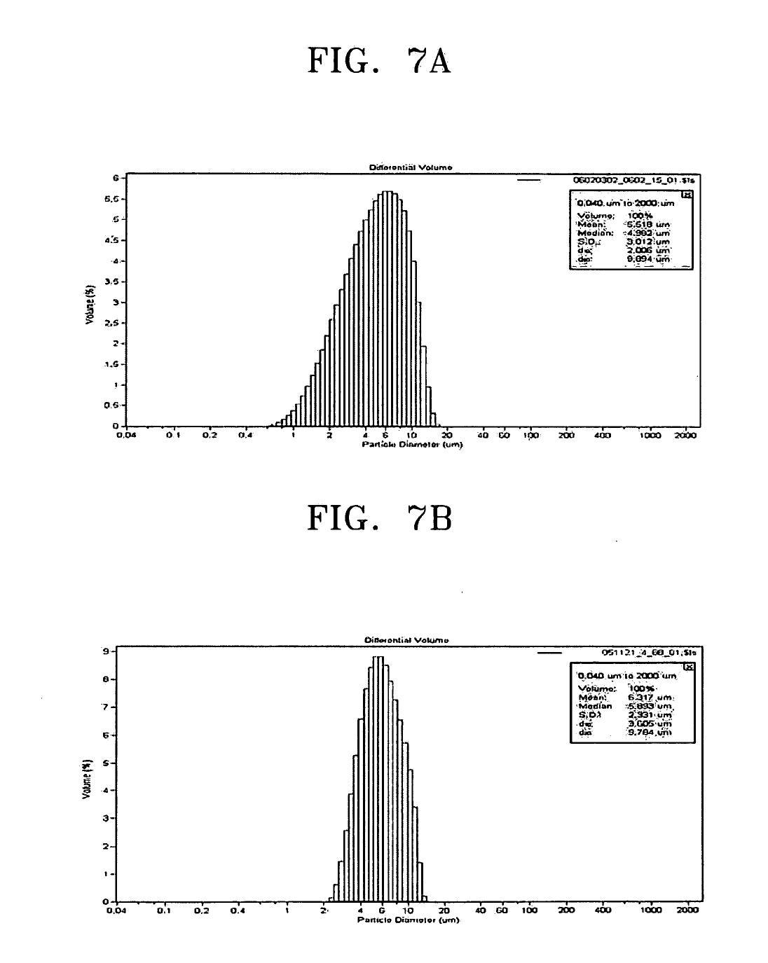

FIG. 6A illustrates the particle size distribution of the toner particles of Comparative Example 1. Referring to FIG. 6A, the particle size distribution of the toner particles of Comparative Example 1 was quite wide and an additional sorting process was required.

FIG. 6B illustrates the particle size distribution of the toner particles of Comparative Example 1 after undergoing a sorting process. The particle size distribution of the toner particles of Comparative Example 1 after the sorting process was narrow.

FIG. 7A illustrates the particle size distribution of the toner particles of Comparative Example 2. Referring to FIG. 7A, the particle size distribution of the toner particles of Comparative Example 2 was quite wide and an additional sorting process was required.

FIG. 7B illustrates the particle size distribution of the toner particles of Comparative Example 2 after undergoing a sorting process. Referring to FIG. 7B, the particle size distribution of the toner particles of Comparative Example 2 after the sorting process was narrow.

As described above, when a polymerizable toner is prepared by suspension polymerization, the particle size of the toner can be efficiently adjusted compared to toner prepared using a conventional suspension polymerization method, and the particle size distribution of the toner according to the present invention is very narrow.

According to the present invention, the diameter of the toner particles can be efficiently adjusted by changing the manufacturing process of the polymerization toner, the distribution of the diameter of the toner particles is improved and thus no additional sorting process is required. Also, the transferring performance of the toner can be improved and various colors can be realized using a simple process, thereby simplifying the process.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preparing a toner comprising the steps of:
preparing a stabilizer dispersion solution from distilled water and a dispersing agent;
forming droplets by discharging a toner composition from a syringe needle into the stabilizer dispersion solution, where the toner composition comprises at least one polymerizable monomer, a colorant, wax, and an initiator;
forming core particles by warming the droplets dispersed in the stabilizer dispersion solution to polymerize the toner composition; and
adding a polymerizable monomer, a cross-linking agent, and an initiator to the stabilizer dispersion solution and the core particles to form shells on the core particles.

2. The method of preparing the toner of claim 1, wherein the dispersing agent is a water-soluble organic polymer dispersing agent, a cellulose based water-soluble resin, or an inorganic dispersing agent.

3. The method of preparing the toner of claim 2, wherein the water-soluble organic polymer dispersing agent is selected from the group consisting of polyvinyl alcohol, polyacrylate salts, polyethylene glycol, polyvinyl pyrrolidone, polyacryl amide, and triphosphoric acid.

4. The method of preparing the toner of claim 2, wherein the cellulose based water-soluble resin is selected from the group consisting of methyl cellulose, hydroxylethyl cellulose, and hydroxylpropyl methyl cellulose.

5. The method of preparing the toner of claim 1, wherein the polymerizable monomer is at least one selected from the group consisting of aromatic vinyl monomer, acrylate monomer, and methacrylate monomer.

6. The method of preparing the toner of claim 1, wherein the polymerizable monomer is at least one selected from the group consisting of styrene, monochlorostyrene, methylstyrene, dimethylstyrene, acrylate, methacrylate, methyl acrylate, ethylacrylate, propylacrylate, butyl acrylate, 2-ethyl hexyl acrylate, methyl methacrylate, ethyl methacrylate, propyl methacrylate, butyl methacrylate, and 2-ethyl hexyl methacrylate.

7. The method of preparing the toner of claim 1, wherein the content of the polymerizable monomer is 3 to 50 parts by weight based on 100 parts by weight of the total content of the toner composition.

8. The method of preparing the toner of claim 1, wherein the colorant is selected from the group consisting of yellow, magenta, cyan, and black pigments.

9. The method of preparing the toner of claim 1, wherein the average inner diameter of the syringe needle is about 0.005 to about 0.1 μm.

10. The method of preparing the toner of claim 1, wherein the cross-linking agent is selected from the group consisting of divinyl benzene, trimethylopropantriacrylate, pentaeritritoltriacrylate, and pentaeritritoltetracrylate.

11. The method of preparing the toner of claim 1, wherein the core particles are formed by reacting the droplets at about 70 to 85° C. for about 8 to 10 hours and then at about 85 to 100° C. for about 2 to 4 hours.

12. The method of preparing the toner of claim 1, wherein the toner composition further comprises at least one selected from the group consisting of a chain transfer agent, a charge control agent, and a releasing agent.

13. The method of preparing the toner of claim 1, further comprising separating and drying the core particles with the shells formed thereon.

14. A toner comprising:
core particles prepared by preparing a stabilizer dispersion solution in a reactor from distilled water and a dispersing agent, forming droplets by discharging a toner composition through a syringe needle into the stabilizer dispersion solution, the toner composition comprising at least one polymerizable monomer, a colorant, wax, and an initiator, and warming the droplets dispersed in the stabilizer dispersion solution in the reactor; and
shells formed on the core particles by adding a polymerizable monomer, cross-linking agent, and initiator to the core particles.

15. The toner of claim 14, wherein the diameter of the toner is about 5 to 100 μm.

16. The toner of claim 14, wherein the polymerizable monomer is at least one selected from a aromatic vinyl monomer, an acrylate monomer, and a methacrylate monomer.

17. The toner of claim 14, wherein the polymerizable monomer is at least one selected from the group consisting of styrene, monochlorostyrene, methylstyrene, dimethylstyrene, acrylate, methacrylate, methyl acrylate, ethyl acrylate, propyl acrylate, butyl acrylate, 2-ethyl hexyl acrylate, methyl methacrylate, ethyl methacrylate, propylmeth acrylate, butyl methacrylate, and 2-ethyl hexyl methacrylate.

18. The toner of claim 14, wherein the toner further comprises at least one selected from the group consisting of an initiator, a chain transfer agent, a charge control agent, and a release agent.

19. A method of forming an image comprising: forming a toned image by attaching a toner to the surface of a photoreceptor on which an electrostatic latent image is formed; and transferring the toned image using a transferring member, wherein the toner is a toner of claim 14.

20. An image forming apparatus comprising: an organic photoreceptor; a charging unit for charging a surface of the organic photoreceptor; a unit for forming an electrostatic latent image on the surface of the organic photoreceptor; a unit for receiving toner; a unit for forming a toned image by developing the electrostatic latent image on the surface of the organic photoreceptor by supplying the toner, and a transferring unit for transferring the toned image from the surface of the photoreceptor to a transferring member, wherein the toner is a toner of claim 14.
